(19) United States
(12) Patent Application Publication
(10) Pub. No.: US 2006/0152018 A1
(43) Pub. Date: Jul. 13, 2006

(54) Cabinet latch

(76) Inventor: David W. Crossley, Charlestown, RI (US)

Correspondence Address: George L. Greenfield;Wolf, Greenfield & Sacks, P.C., 600 Atlantic Avenue, Boston, MA, 02210-2206, US

(21) Appl. No.: 11/034,397

(22) Filed: Jan. 12, 2005

(51) Int. Cl. E05C 19/10

(52) U.S. Cl. 292/246

(57) ABSTRACT

A cabinet or drawer latch composed of a catch and latch that may be molded of a plastic material and free of sharp edges that may pinch a child's fingers when the cabinet door or drawer is closed. The latch includes a bail that possesses sufficient flexibility so that it can deflect and ride over a camming surface on the catch so as to achieve a locking position with the catch. The latch may be deflected when the door or drawer is open slightly and which is permitted by the interengaged catch and latch so that the latch may disengage the catch and permit the drawer or door to be fully opened.

### BACKGROUND OF INVENTION

### Field of Invention

This invention relates to cabinet and drawer latches and more particularly to latches that prevent young children from gaining access to cabinet and drawer interiors.

### SUMMARY OF INVENTION

The latch assembly of the present invention in its preferred form is comprised of two parts, namely, a latch and a catch. These two parts may be made of a variety of materials, but preferably they are each molded as a unitary structure of a plastic material that affords the latch sufficient flexibility so that a caregiver can deflect the latch so as to disengage it from the catch, but which is beyond the skills of a young child.

Another aspect of the present invention relates to the configuration of the latch. The latch is free of sharp edges and comers so that if a youngster places a hand or fingers in the path of the latch as the door or drawer is being closed, the child's fingers will not be cut, jammed or otherwise injured by the latch and/or catch. The leading face of the latch is a relatively large and rounded surface so as not likely to pinch the fingers of a child when the parts come together as the door or drawer is closed.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a side view of a latch assembly in accordance with one embodiment of the present invention, shown mounted on a cabinet with the cabinet door open;

FIG. 2 is a view similar to FIG. 1 but showing the door fully closed with the latch assembly engaged;

FIG. 3 is a view similar to FIGS. 1 and 2 but showing the door open slightly and the latch engaged to prevent the cabinet door from being fully opened;

FIG. 4 is a view similar to FIGS. 1-3 and showing the latch being displaced so that the door may be fully opened;

FIG. 5 is a perspective view of the latch and catch that comprise the latch assembly shown in FIGS. 1-4 and with the latch and catch disengaged;

FIG. 6 is a view similar to FIG. 5 but showing the latch engaging the catch;

FIG. 7 is a top plan view of the latch and catch separated from one another as in FIG. 5;

FIG. 8 is a top plan view similar to FIG. 7 but showing the latch and catch engaged;

FIG. 9 is a cross-sectional view of the latch and catch, taken along section line 9-9 in FIG. 7;

FIG. 10 is a side elevation view of the disengaged latch and catch; and

FIG. 11 is a side elevation view similar to FIG. 10 with the latch and catch engaged.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

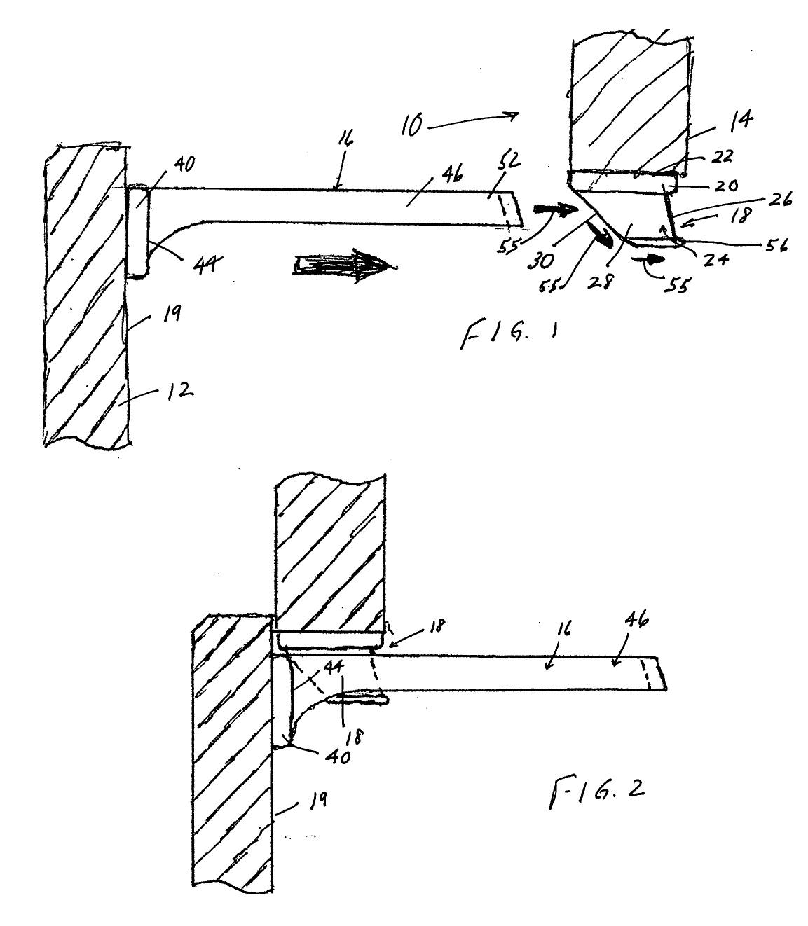

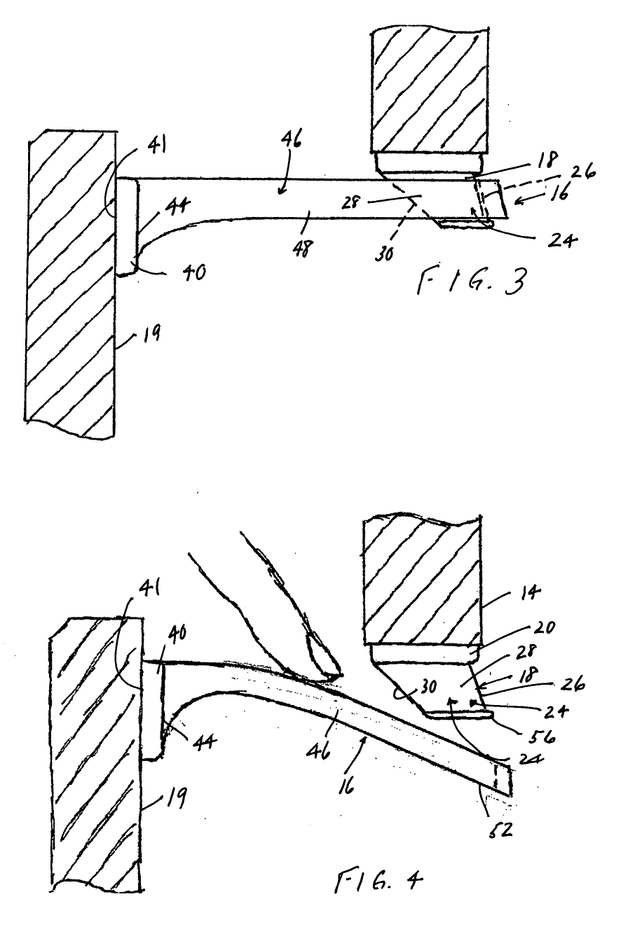

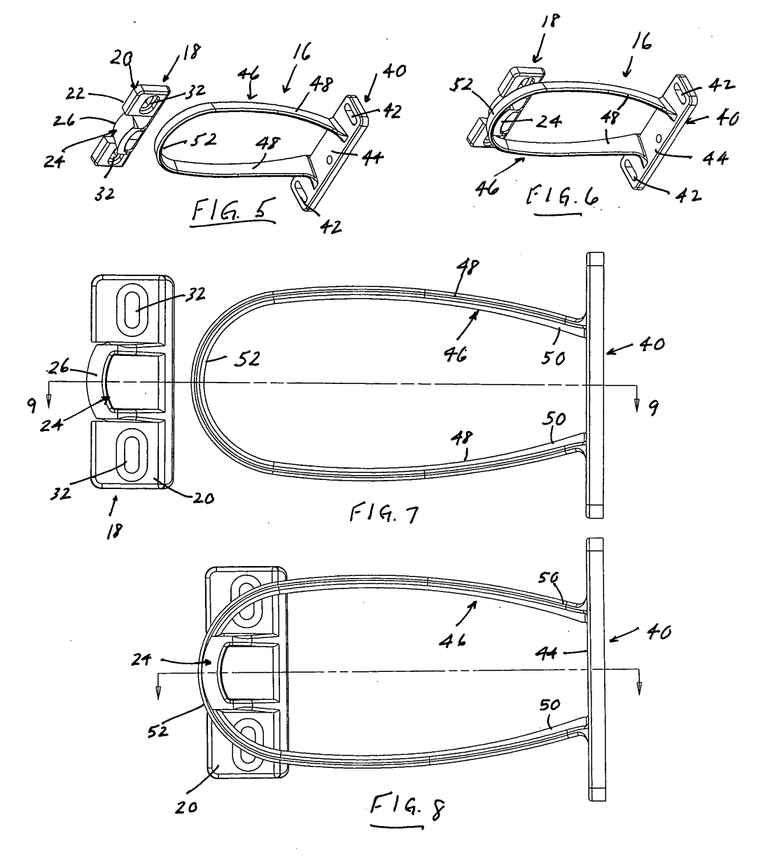

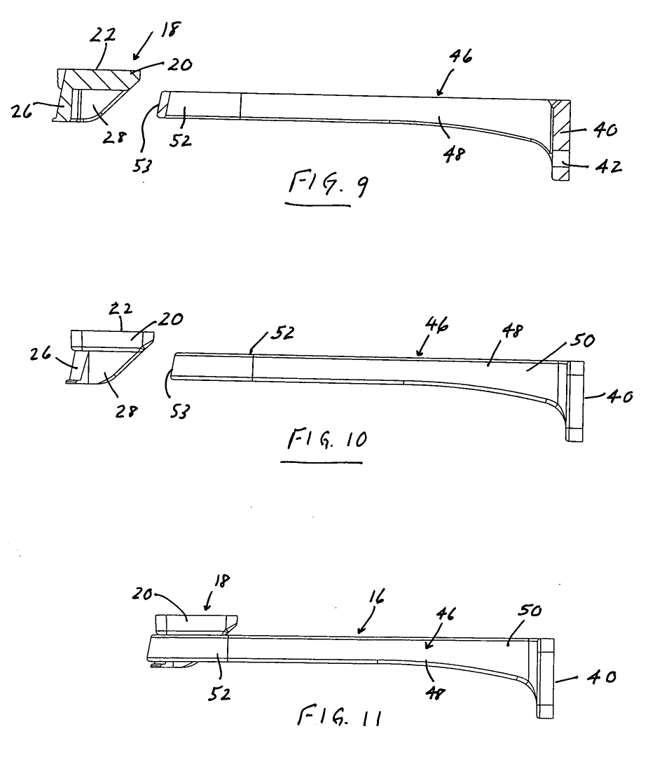

In FIG. 1 the cabinet latch assembly of the present invention is shown mounted on a cabinet 10 that includes a door 12 and rail 14 and serves to prevent access to the cabinet by a toddler or young child. While this is a typical application for the present invention, it may be used with equal facility and benefit as a drawer closure to prevent access to the drawer interior by a young child. The latch assembly, however, may be readily released by an adult or other caregiver by opening the door or drawer a limited distance as shown in FIG. 3 so that the caregiver's fingers may be inserted behind the door as suggested in FIG. 4 or into a drawer to deflect the latch and thereby release it. These operations and the cabinet latch are described in greater detail below.

The latch assembly of the present invention is composed of two principal parts, namely, the latch 16 and catch 18. In FIGS. 1-4 the latch 16 is shown mounted on the inner surface 19 of door 12, and the catch 18 is shown mounted on the cabinet rail 14. In this application, the catch is stationary while the latch moves with the door on which it is mounted. However, in many applications, the mounting of the latch and catch may be reversed.

The catch 18 includes a base 20 having a face 22 adapted to be readily mounted on the cabinet rail 14. A collar 24 that is approximately semi-cylindrical in shape having a rounded rear surface 26 that joins a pair of spaced apart side walls 28, is mounted on the base 20. Both the semi-cylindrical surface 26 and side walls 28 extend downwardly from the base 20 and the semi-cylindrical surface 26 tapers downwardly and rearwardly from the base and away from the cabinet. The front edges 30 of the side walls 28 serve as ramps for deflecting the latch 16 as it approaches the catch 18. (Note the arrows in FIG. 1.) To facilitate mounting the catch on the cabinet rail, a pair of countersunk holes 32 are provided in the base, one on each side of the collar 24, and sized to receive a typical wood screw, preferably flat headed, so as to lie wholly within the countersunk portions of the holes 32. The holes 32 are elongated so as to allow the position of the catch to be adjusted when the positions of the catch and latch are established on the rail and door to achieve proper alignment of the catch and latch.

The latch 16 has a foot 40 for attaching the latch to the door. The foot is typically a rectangular shaped plate that may be other shapes as well, and has a pair of holes 42, one adjacent each end of the foot 40, for receiving fasteners such as wood screws to secure the foot in place. Like the holes 32 in the base of the catch 18, the holes 42 are also elongated to assist in achieving proper alignment of the catch and latch during mounting. The foot 40 on its exposed surface 44 carries a bail 46 that is generally U-shaped having spaced apart arms 48 secured at their ends 50 to the face 44 of the foot. The other ends of the arms 48 are joined by an arcuate segment 52 preferably having a radius of curvature complimentary to the semi-cylindrical portion 26 of the collar 24 of the catch 18. The spacing of the arms at the junction with the curved portion 52 is substantially greater than the lateral extent of the collar 24 of the catch. As shown in FIGS. 9 and 10, the outside surface 53 of the arcuate segment 52 preferably is inclined to compliment the cam surface 30 of the catch 18 to assist in forcing the bail to bend under the catch and snap into position on the bail outer surface 26.

In the preferred form of the invention, the latch 16 is a unitary structure, preferably molded of a plastic material such as polypropylene so that the bail 46 is rigid enough to maintain the essentially horizontal position shown but which is sufficiently flexible so that without too much force, the curved portion 52 may be manually deflected downwardly below the bottom surface 34 of the collar 24 of the catch. While polypropylene is the preferred material for forming the latch 16, and the same material may be used for the catch 18, other materials such as polycarbonate, acetal (POM), or nylon may be used as well. It should be noted that the catch need not exhibit any flexible qualities as in normal operation the catch is fixed and does not require that any of its parts be deflectable.

The latch 16 and catch 18 are aligned with one another on the door 12 and cabinet rail 18. That is, the bail is aligned with the collar 24 so that as they move toward one another as the door closes, the curved segment 52 of the bail will engage the ramps 30 formed at the back or free edges of the side walls 28. The segment 52 of the bail should engage the camming surfaces or ramps 30 that will deflect the bail downwardly on the collar 24 as suggested by the arrows 55 so that ultimately the curved segment passes beneath the side walls 28 and beyond the bottom of the semi-cylindrical portion 26 of the collar. Ultimately, the curved segment 52 passes beyond the collar and the bias of the bail causes it to climb upwardly about the collar to the locked or engaged position as shown in FIG. 3. The semi-cylindrical portion 26 of the collar carries a flange 56 along its bottom edge that resists the bail slipping downwardly on the collar after its curved portion 52 assumes the locking position surrounding the collar.

It should be noted in FIG. 2 that when the cabinet door is fully closed, the curved segment 52 of the bail extends a short distance beyond the collar 24 of the catch 18 so as to permit the door to be partially opened as in FIG. 3. This enables a caregiver to slip his/her finger or fingers behind the door and deflect the bail 46 so that the door may be fully opened and provide access to the cabinet interior. That manipulation, however, is beyond the ability of a young child.

Typically the overall length of the latch 16 measured from the back surface 41 of the foot 40 to the outer surface of the curved segment 52 may be approximately 3.8 inches, the bail 46 at its widest point may be approximately 1.8 inches, and the front to back depth of the catch collar 26 may be approximately 0.75 inches. Therefore, if the rail 14 of the cabinet is approximately 0.75 inch in thickness and the latch 16 is mounted on the door at the edge remote from the door hinge, the door opening permitted by the engaged latch and catch will be less than approximately 3 inches. These dimensions are given by way of example only, and it should be appreciated that the latch assembly may be made in a wide variety of sizes suitable for a variety of applications.

While in the foregoing description the catch and latch are described as being disposed in a horizontal orientation and with the collar 24 of the catch extending downwardly from the base 20, it should be appreciated that the latch assembly may be inverted so that the collar extends upwardly from the base assuming that the horizontal orientation of the assembly is chosen. The assembly may also be oriented in appropriate circumstances dictated by the configuration of cabinet or drawer controlled by it, in a vertical plane, that is, with the bail disposed with one arm 48 above the other. In any orientation, when the door or drawer is closed, the bail 46 will surround the collar with sufficient freedom between the two so as to permit the door or drawer to be opened slightly to provide finger room to enable a person to deflect the bail so that the cabinet or drawer may be fully opened.

Because of the configuration and material from which the latch assembly is made, a child is most unlikely to get its fingers pinched or bruised by accidentally closing the door or drawer on them. Particularly, the absence of sharp corner, the curvature of the bail and the softness of the material from which it is made will avoid the likelihood of injury.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A cabinet latch assembly comprising,
a catch having a base for attachment to one or the other of a cabinet frame or door,
a collar attached to and extending away from the base,
a latch having a foot for attachment to the other of frame or door of the cabinet,
a U-shaped bail forming part of the latch with the ends of the bail attached to the foot,
the bail having a closed end remote from the foot and sized to extend about the collar when the latch engages the catch for preventing the door from being fully opened,
and a ramp on the catch for guiding the closed end of the bail when it approaches the catch as the door is closed causing the bail to ride up and over the collar and be captured by the catch.

2. The latch assembly of claim 1 wherein the collar is generally U-shaped in cross-section and is inclined away from the closed end of the bail and to the base.

3. The latch assembly of claim 1 wherein the ramp is on the side of the collar facing the bail as the door is closed.

4. The latch assembly of claim 1 wherein the latch is made of a material enabling the bail to be deflected beyond the plane of the end of the collar when engaged by the ramp.

5. The latch assembly of claim 1 wherein the closed end of the bail extends beyond the collar when the door is fully closed enabling the door to be partially opened while the bail extends about the collar.

6. The latch assembly of claim 1 wherein the closed end of the bail is a smooth curve free of sharp corners and made of a yieldable material for preventing injury to a person's hand or fingers disposed between the latch and catch when the door is moving to the closed position.

7. A latch assembly for releasably holding a door or drawer face in the closed position comprising,
a relatively rigid catch having attaching means for securing it to fixed structure adjacent the door or drawer face, said catch having a collar extending away from the attaching means and inclined toward its free end away from the door or drawer face, said collar having a smooth curved surface facing away from the door or drawer face,
a latch having a generally U-shaped bail, said bail having arms attached to the door or drawer face, said bail having a curved closed end for encircling the collar when the door or drawer face is closed,
the bail being disposed in a plane that intersects the collar,
and a ramp on the catch for engaging the bail to move the curved end to a plane beyond the free end of the collar so that the closed end can pass over and encircle the collar and resume its biased position in the plane intersecting the collar.

8. A latch assembly having a catch and a latch, said latch being molded as a one piece unitized structure with a curved member that can encircle the catch and be manually deflected to disengage the catch.

9. The assembly of claim 8 wherein the curved member surrounds the catch and prevents separation of the latch and catch unless the curved member is manually deflected away from the latch.

10. A latch assembly comprising
a catch and a latch for mounting on separate members to be releasably locked together,
said catch including a collar and said latch including a bail for encircling the catch when the members are to be locked together, said catch being relatively rigid and said latch being made of a yieldable material that enables the bail to be deflected away from the catch to release the collar when the members are to be released from one another,
said collar having a ramp for causing the bail to deflect out of the path of the collar as the members move toward one another and pass beyond the catch and thereafter deflecting toward the catch so as to encircle the collar to lock the members together.
